(19) United States
(12) Patent Application Publication
(10) Pub. No.: US 2014/0196809 A1
(43) Pub. Date: Jul. 17, 2014

(54) Low Flow Drain Pipe

(71) Applicant: Gary Klein, Rancho Cordova, CA (US)

(72) Inventor: Gary Klein, Rancho Cordova, CA (US)

(21) Appl. No.: 13/740,179

(22) Filed: Jan. 12, 2013

(51) Int. Cl. F15D 1/02; F16L 21/00

(52) U.S. Cl. CPC F15D 1/02; F16L 21/00
USPC 138/39; 285/328

(57) ABSTRACT

A pipe fitting includes a pipe fitting body having a first end in fluidic communication with a second end, the ends configured to receive a pipe. At least one of the first or second ends comprises a non-circular sectional shape having a low flow enhancement channel disposed at a bottom. The low flow enhancement channel is configured to comprise a first depth of a fluid that is greater than a second depth of the same fluid in a substantially circular section pipe where the non-circular sectional shape and the circular section pipe comprise substantially the same overall cross sectional area. A stand may be associated with the pipe fitting, the stand configured to accept the pipe fitting body in an orientation where the low flow enhancement channel is disposed at the bottom of the non-circular shape.

### CROSS-REFERENCE TO RELATED APPLICATIONS

This application is a utility patent application that claims priority to provisional application 61/586,435 filed on Jan. 13, 2012 the contents of which are fully incorporated herein with this reference.

### DESCRIPTION

1. Field of the Invention

The present invention generally relates to drain pipes. More particularly, the present invention relates to a drain pipe with a special shape and orientation that reduces clogs and obstacles.

2. Background of the Invention

A drain pipe is a tubular section or hollow cylinder used mainly to convey substances which can flow such as liquids and slurries containing both suspended particles and masses of small solids. Drain pipes are used throughout modern residences and buildings. A drain pipe is connected to all the bathtubs, sinks, toilets and other equipment and appliances that discharge water and water borne wastes. The drain pipe conveys waste from the residence or building to the sewer system. Waste can then be transported to a waste recycling plant or dumped into a safe landfill or environment.

A drain pipe works by allowing gravity to flow the waste material onward and outward. This means that the drain pipe is usually installed in a downward manner such that waste will naturally flow by gravity to the sewer system. A drain pipe may either be positioned vertically, at an angle or sometimes (almost) horizontal. When almost horizontal, building and plumbing codes require that a downward slope, such as 1-2%, be maintained to ensure proper drainage. Care is always taken not to install or design a system where the drain pipe will travel at an upward slope.

Even when care is taken to properly design and install drain pipes, blockages may occur. Over repeated use, deposits can accumulate on the inside surface of the drain pipe preventing waste from flowing onward. Also, waste can dry in various spots and become further obstacles.

Today, the use of low flow toilets has increased. A low flow toilet is characterized by a smaller amount of water being used with each flush as compared to older toilets. This means there is less water conveying waste inside the drain pipe than in the past. Therefore, the low flow toilet and other general problems can lead to obstacles being formed within a drain pipe.

Accordingly, there is a need for a new drain pipe design that eliminates or reduces the problems of waste blockage. The present invention fulfills these needs and provides other related advantages.

### SUMMARY OF THE INVENTION

An exemplary embodiment of the present invention includes a pipe fitting. The pipe fitting includes a pipe fitting body comprising a first end in fluidic communication with a second end. The first and second ends are each configured to receive a pipe. At least one of the first or second ends comprise a non-circular sectional shape. The non-circular sectional shape comprises a low flow enhancement channel disposed at a bottom of the non-circular sectional shape.

In an exemplary embodiment the low flow enhancement channel comprises a first radius smaller than an upper or a middle radius of the non-circular sectional shape.

In an exemplary embodiment a first area is defined as comprising a lower half of the non-circular sectional shape which is less than a second area defined as comprising an upper half of the non-circular sectional shape.

In an exemplary embodiment a first area is defined as comprising a lower third of the non-circular sectional shape which is less than a second area defined as comprising a middle third of the non-circular sectional shape.

In an exemplary embodiment a first area is defined as comprising a lower third of the non-circular sectional shape which is less than a third area defined as comprising an upper third of the non-circular sectional shape.

In an exemplary embodiment the low flow enhancement channel is configured to comprise a first depth of a fluid that is greater than a second depth of the same fluid in a substantially circular section pipe where the non-circular sectional shape and the circular section pipe comprise substantially the same overall cross sectional area.

In an exemplary embodiment the non-circular sectional shape comprises an oval or an ellipse. The major axis of the oval or ellipse is oriented vertically.

In an exemplary embodiment the non-circular sectional shape comprises a triangle. An angle of the triangle is oriented at the bottom and a side of the triangle is oriented at a top such that the side is oriented substantially horizontal.

In an exemplary embodiment both the first and second ends comprise the non-circular sectional shape.

In an exemplary embodiment an outside orientation feature is attached to the pipe fitting body. The outside orientation feature may comprise a fastener aperture vertically disposed in relation to the non-circular sectional shape. The outside orientation feature may comprise a spike vertically disposed in relation to the non-circular sectional shape. The outside orientation feature may comprise a stand horizontally disposed in relation to the non-circular sectional shape. The outside orientation feature may comprise an auxiliary tool receiver, such that an auxiliary tool may be removable attached to the auxiliary tool receiver.

In an exemplary embodiment a stand may be associated with the pipe fitting. The stand may be configured to accept the pipe fitting body in an orientation where the low flow enhancement channel is disposed at the bottom of the non-circular sectional shape.

In an exemplary embodiment the non-circular sectional shape comprises an inside of the pipe fitting body and an outside of the pipe fitting body comprises a circular sectional shape. The pipe fitting body may comprise a resiliently flexible and compressible material.

In an exemplary embodiment the pipe fitting body comprises a bend. The bend may be substantially horizontal or vertical.

In an exemplary embodiment a third end may be in fluidic communication with the first and second ends, the third end also configured to receive the pipe.

An exemplary embodiment of the present invention includes a pipe fitting. The pipe fitting includes a pipe fitting body comprising a first end in fluidic communication with a second end. The first and second ends are configured to receive a pipe. At least one of the first or second ends comprise a non-circular sectional shape. The non-circular sectional shape comprises a low flow enhancement channel disposed at a bottom of the non-circular sectional shape. The low flow enhancement channel is configured to comprise a first depth of a fluid that is greater than a second depth of the same fluid in a substantially circular section pipe where the non-circular sectional shape and the circular section pipe comprise substantially the same overall cross sectional area.

An exemplary embodiment of the present invention includes a pipe fitting. The pipe fitting includes a pipe fitting body comprising a first end in fluidic communication with a second end. The first and second ends are configured to receive a pipe. At least one of the first or second ends comprise a non-circular sectional shape. The non-circular sectional shape comprises a low flow enhancement channel disposed at a bottom of the non-circular sectional shape. The low flow enhancement channel is configured to comprise a first depth of a fluid that is greater than a second depth of the same fluid in a substantially circular section pipe where the non-circular sectional shape and the circular section pipe comprise substantially the same overall cross sectional area. A stand is associated with the pipe fitting. The stand is configured to accept the pipe fitting body in an orientation where the low flow enhancement channel is disposed at the bottom of the non-circular shape.

An exemplary embodiment of the present invention includes a non-circular pipe. The non-circular pipe includes a pipe body comprising a first end in fluidic communication with a second end. The pipe body comprises a singular cross sectional shape between the first end and second end. The singular cross sectional shape comprises a non-circular sectional shape. The non-circular sectional shape comprises a low flow enhancement channel disposed at a bottom of the non-circular sectional shape. The low flow enhancement channel is configured to comprise a first depth of a fluid that is greater than a second depth of the same fluid in a substantially circular section pipe where the non-circular sectional shape and the circular section pipe comprise substantially the same overall cross sectional area. Waste blockage is prevented or reduced from accumulating along the bottom of the non-circular sectional shape as compared to the circular section pipe. A stand may be associated with the pipe. The stand may be configured to accept the pipe body in an orientation where the low flow enhancement channel is disposed at the bottom of the non-circular sectional shape.

Other features and advantages of the present invention will become apparent from the following more detailed description, when taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a sectional view of a prior art drain pipe;

FIG. 2 is a sectional view of an exemplary drain pipe embodying the present invention;

FIG. 3A is a side view of an exemplary drain pipe fitting embodying the present invention;

FIG. 3B is a bottom view of the structure of FIG. 3A;

FIG. 3C is a side view of the structure of FIG. 3A;

FIG. 3D is a side view of the structure of FIG. 3A;

FIG. 3E is a sectional view of the structure of FIG. 3A taken along lines 3E-3E;

FIG. 3F is a simplified representation of the view of FIG. 3C;

FIG. 3G is a simplified representation of the view of FIG. 3D;

FIG. 3H is a perspective view of the structure of FIG. 3A;

FIG. 3I is a perspective view of the structure of FIG. 3A;

FIG. 4A is a side view of an exemplary drain pipe fitting embodying the present invention;

FIG. 4B is a bottom view of the structure of FIG. 4A;

FIG. 4C is a side view of the structure of FIG. 4A;

FIG. 4D is a side view of the structure of FIG. 4A;

FIG. 4E is a sectional view of the structure of FIG. 4A taken along lines 4E-4E;

FIG. 4F is a simplified representation of the view of FIG. 4C;

FIG. 4G is a simplified representation of the view of FIG. 4D;

FIG. 4H is a perspective view of the structure of FIG. 4A;

FIG. 4I is a perspective view of the structure of FIG. 4A;

FIG. 5A is a side view of an exemplary drain pipe fitting embodying the present invention;

FIG. 5B is a bottom view of the structure of FIG. 5A;

FIG. 5C is a side view of the structure of FIG. 5A;

FIG. 5D is a side view of the structure of FIG. 5A;

FIG. 5E is a sectional view of the structure of FIG. 5A taken along lines 5E-5E;

FIG. 5F is a perspective view of the structure of FIG. 5A;

FIG. 5G is a perspective view of the structure of FIG. 5A;

FIG. 6A is a side view of an exemplary drain pipe fitting embodying the present invention;

FIG. 6B is a bottom view of the structure of FIG. 6A;

FIG. 6C is a side view of the structure of FIG. 6A;

FIG. 6D is a side view of the structure of FIG. 6A;

FIG. 6E is a sectional view of the structure of FIG. 6A taken along lines 6E-6E;

FIG. 6F is a perspective view of the structure of FIG. 6A;

FIG. 6G is a perspective view of the structure of FIG. 6A;

FIG. 7 is a sectional view of an exemplary drain pipe embodying the present invention now buried in the ground;

FIG. 8 is similar to FIG. 7 now with the drain pipe incorrectly oriented;

FIG. 9 is a sectional view of an exemplary drain pipe embodying the present invention;

FIG. 10 is a sectional view of an exemplary drain pipe embodying the present invention;

FIG. 11 is a perspective view of an exemplary drain pipe fitting embodying the present invention with an outside orientation feature;

FIG. 12 is a perspective view of an exemplary drain pipe fitting embodying the present invention with an outside orientation feature;

FIG. 13 is a perspective view of an exemplary drain pipe fitting embodying the present invention with an outside orientation feature;

FIG. 14 is a perspective view of an exemplary drain pipe fitting embodying the present invention with an auxiliary tool receiver and auxiliary tool;

FIG. 15 is a perspective view of an exemplary drain pipe fitting embodying the present invention with an outside orientation feature;

FIG. 16 is a side view of an exemplary drain pipe and stand embodying the present invention;

FIG. 17 is a perspective view of a prior art pipe coupler;

FIG. 18A is a side view of an exemplary pipe fitting embodying the present invention and the prior art coupler of FIG. 17;

FIG. 18B is a side view of another exemplary pipe fitting embodying the present invention and the prior art coupler of FIG. 17;

FIG. 19 is a perspective view of an exemplary drain pipe fitting embodying the present invention now with a horizontal bend;

FIG. 20 is a perspective view of an exemplary drain pipe fitting embodying the present invention now with a vertical bend; and

FIG. 21 is a perspective view of an exemplary drain pipe fitting embodying the present invention now showing a t-style fitting.

### DETAILED DESCRIPTION OF THE PREFERRED EMBODIMENTS

FIG. 1 is a sectional view of a prior art drain pipe 10. The drain pipe 10 is circular in cross sectional shape as most drain pipes currently in use are. The drain pipe has a solid waste 12 and a liquid waste 14. When the liquid level 14 is not sufficient enough to move the solid waste 12 onward, the solid waste 12 may become logged or affixed to the inside surface of the drain pipe 10.

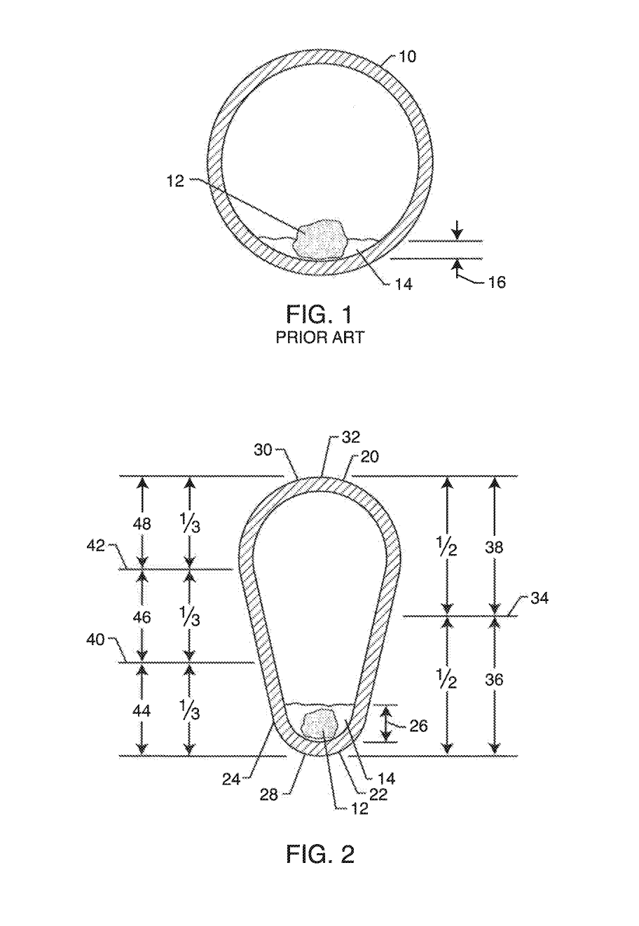

FIG. 2 is a sectional view of an exemplary drain pipe 20 embodying the present invention. The drain pipe 20 has a non-circular sectional shape. In this exemplary embodiment, the drain pipe 20 is shaped to form a low flow enhancement channel 22 disposed at the bottom 24 of the drain pipe 20. The low flow enhancement channel 22 creates a taller or higher height of the waste such that it flows better thereby preventing obstacles or obstructions in the drain pipe 20. In FIG. 1 the height of the liquid waste is 16. In FIG. 2 the height of the liquid waste is 26, which is taller than the liquid waste 16. The non-circular sectional shape 20 and the circular section pipe 10 comprise substantially the same overall cross sectional area, yet the depth 26 is greater than the depth 16.

There is another way to view how the drain pipe 20 can be shaped. The first radius 28 is smaller than an upper/middle radius 30 located near a top 32 of the non-circular sectional shape 20. The smaller radius 28 forces a greater depth 26 as compared to the depth 16 of the drain pipe 10.

In yet another way to view how the drain pipe 20 can be shaped, the drain pipe 20 can be divided in half along line 34. Line 34 is evenly split between the top 32 and the bottom 24. A first area 36 is defined as comprising a lower half of the non-circular sectional shape 20 between the bottom 24 and the middle line 34. A second area 38 is defined as comprising an upper half of the non-circular sectional shape 20 between the middle line 34 and the top 30. The first area 36 is less than the second area 38. The smaller area at the bottom creates a greater depth 26 as compared to the depth 16 of the drain pipe 10.

In yet another way to view how the drain pipe 20 can be shaped, the drain pipe 20 can be divided into thirds along lines 40 and 42. Lines 40 and 42 are evenly split into thirds between the bottom 24 and the top 32. A first area 44 is defined as comprising a lower third of the non-circular shape 20 between the bottom 24 and the line 40. A second area 46 is defined as comprising a middle third of the non-circular shape 20 between the line 40 and line 42. A third area 48 is defined as comprising an upper third of the non-circular shape between line 42 and the top 32. The area 44 is less than the area of 46 or the area 48. The smaller area 44 at the bottom creates a greater depth 26 as compared to the depth 16 of the drain pipe 10.

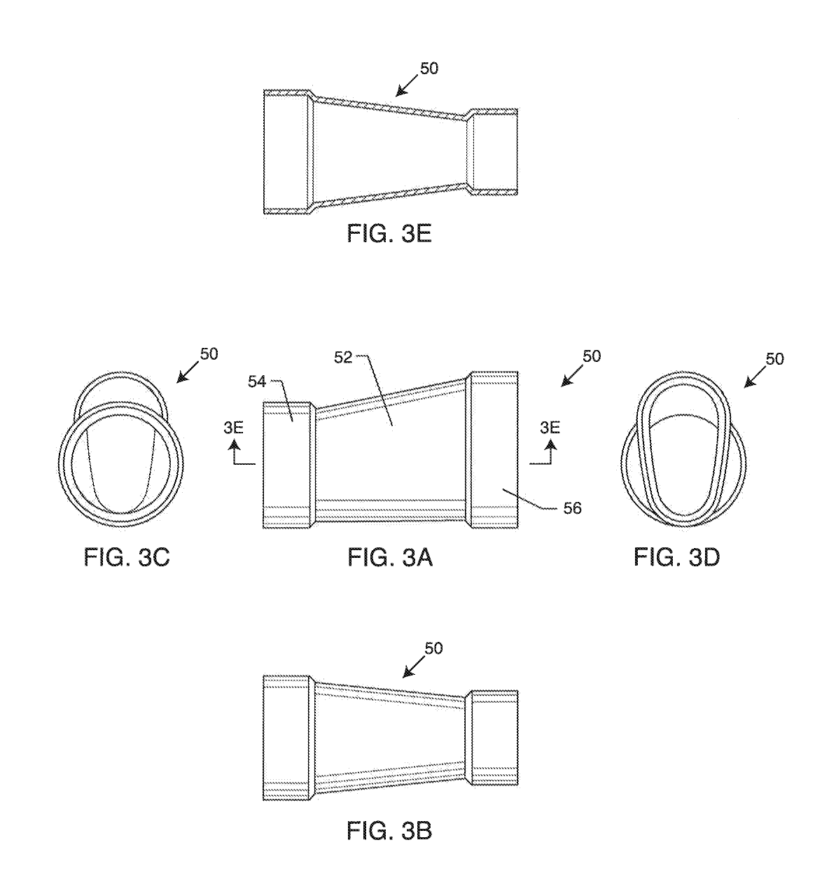

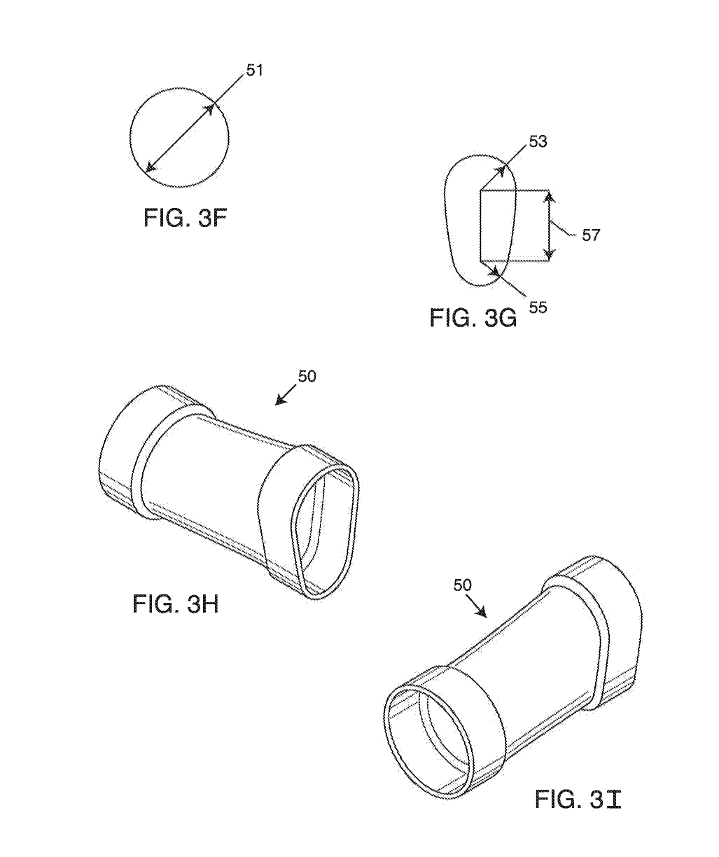

FIGS. 3A-I are an exemplary embodiment of a drain pipe fitting 50. The drain pipe fitting 50 has a pipe fitting body 52 comprising a first end 54 in fluidic communication with a second end 56. Both the first end 54 and second end 56 are each configured to receive a pipe 20 of the present invention or a pipe 20 of the prior art. One skilled in the art will recognize that either ends may be considered the first or second ends. One skilled in the art will also recognize that both ends of the drain pipe fitting 50 could be comprised of a plurality of varying non-circular shapes and this disclosure is not intended to limit it just to the precise forms shown and described herein. In this particular embodiment, the drain pipe 10 of FIG. 1 could be fit within and sealed with the first end 54. Then, the drain pipe 20 of FIG. 2 could be fit within and sealed with the second end 56. In this way a transition from the prior art to the present invention is easily accomplished. The materials of the drain pipe fitting 50 are common in the art including, but not limited to, PVC or other various plastics, metals, composites and combinations thereof. Materials and techniques of the seals are also commonly known in the prior art to create leak free joints.

To make the present invention comply with various plumbing codes, the overall cross sectional area of FIGS. 1 and 2 should be substantially the same such that the same maximum volume of waste can be flowed in a similar manner. Accordingly, FIGS. 3F and 3G show how similar overall cross sectional areas can be obtained. In this example, the diameter 51 will be considered to be 4 inches. This means the area of FIG. 3F is 12.56 square inches. To make the overall cross sectional area of FIG. 3G equal to 12.56 square inches, the top radius 53 will be 1.50 inches, the bottom radius 55 will be 1.00 inch and the distance 57 will be about 2.82 inches.

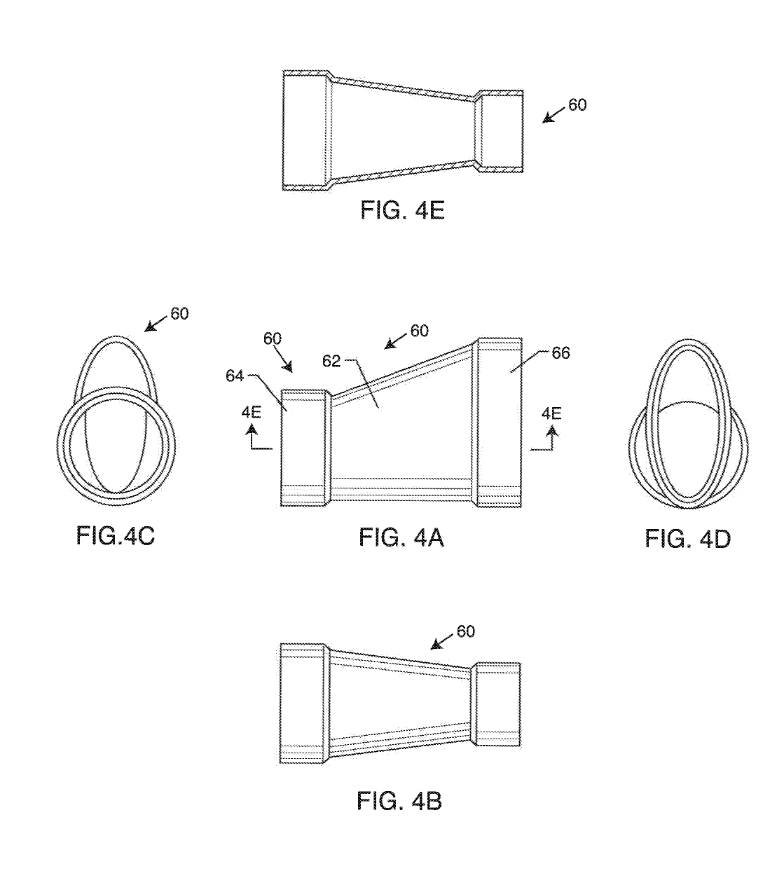

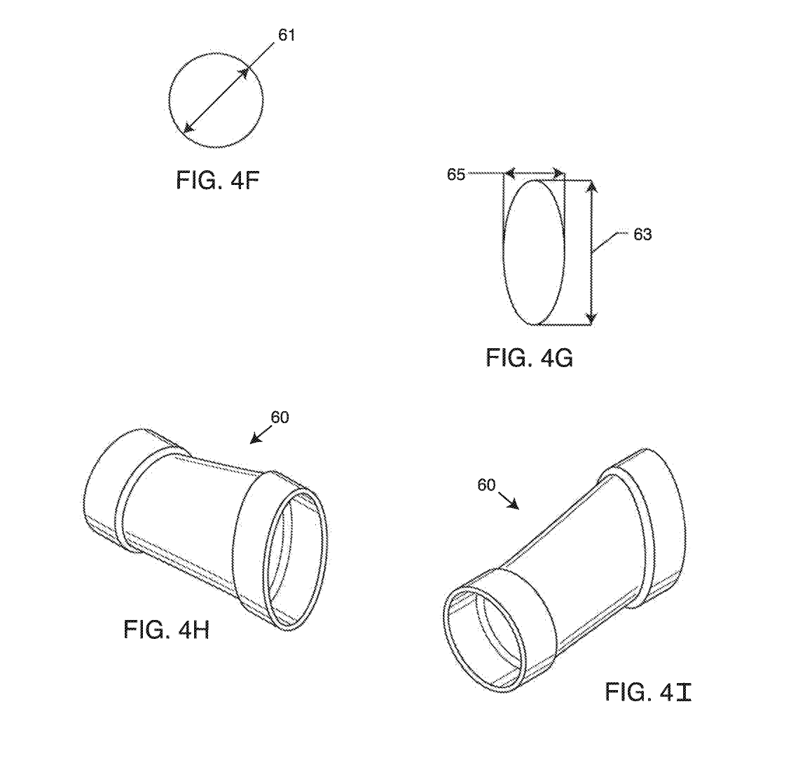

FIGS. 4A-I are another exemplary embodiment of a drain pipe fitting 60. The drain pipe fitting 60 has a pipe fitting body 62 comprising a first end 64 in fluidic communication with a second end 66. Both the first end 64 and second end 66 are each configured to receive a pipe 20 of the present invention or a pipe 20 of the prior art. One skilled in the art will recognize that either ends may be considered the first or second ends. One skilled in the art will also recognize that both ends of the drain pipe fitting 50 could be comprised of a plurality of varying non-circular shapes and this disclosure is not intended to limit it just to the precise forms shown and described herein. In this particular embodiment, the drain pipe 10 of FIG. 1 could be fit within and sealed with the first end 64. Then, an oval/elliptical shaped drain pipe could be fit within and sealed with the second end 66. In this way a transition from the prior art to the present invention is easily accomplished.

To make the present invention comply with various plumbing codes, the overall cross sectional areas of FIGS. 4F and 4G should be substantially the same such that the same maximum volume of waste can be flowed in a similar manner. In this example, the diameter 61 will be considered to be 4 inches. This means the area of FIG. 4F is 12.56 square inches. To make the overall cross sectional area of FIG. 4G equal to 12.56 square inches, the length of the major axis 63 will be about 6.16 inches and the length of the minor axis will be about 2.60 inches.

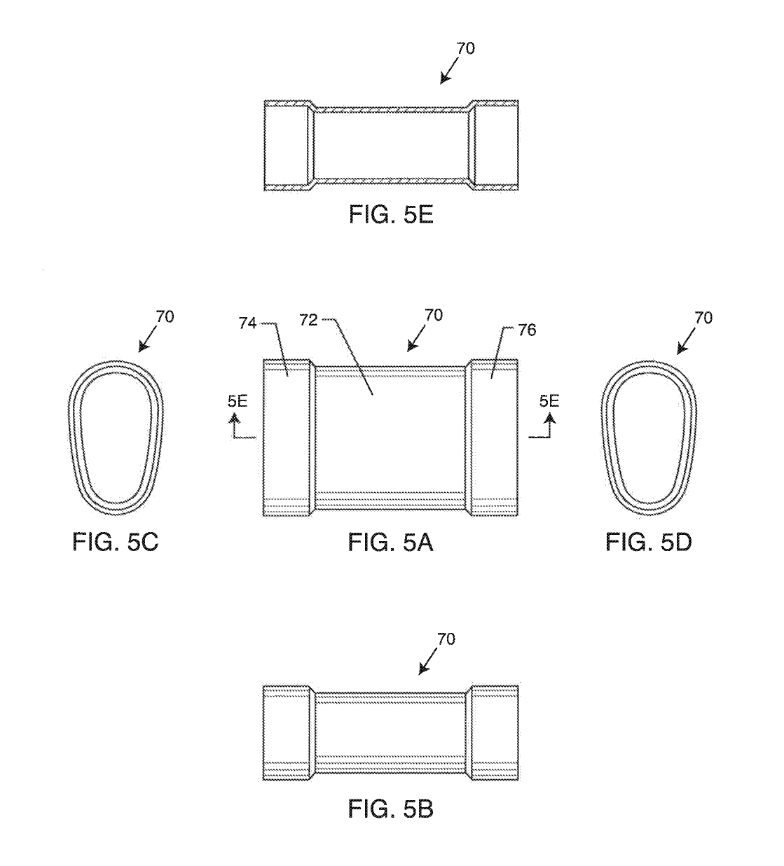

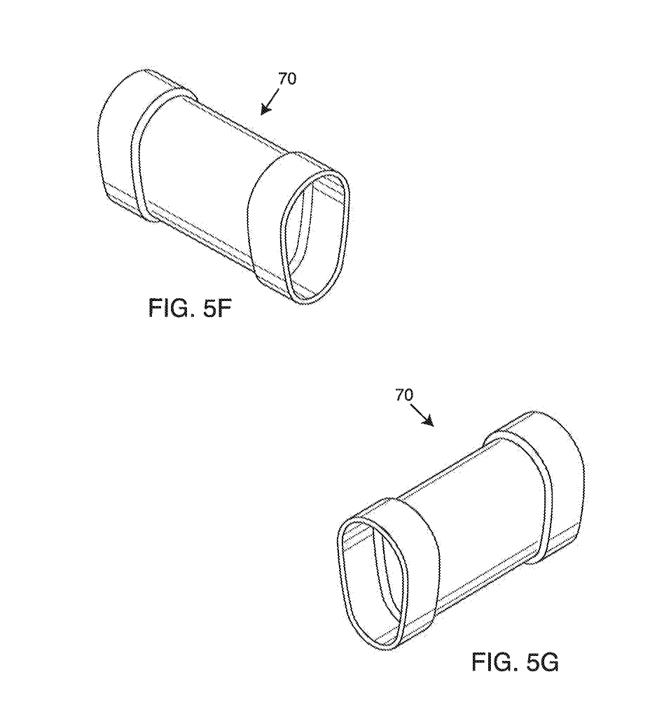

FIGS. 5A-I are yet another exemplary embodiment of a drain pipe fitting 70. The drain pipe fitting 70 has a pipe fitting body 72 comprising a first end 74 in fluidic communication with a second end 76. Both the first end 74 and second end 76 are each configured to receive a pipe 20 of the present invention. As can be seen by those skilled in the art, a variety of non-circular shapes could be configured that creates a low flow enhancement channel 22.

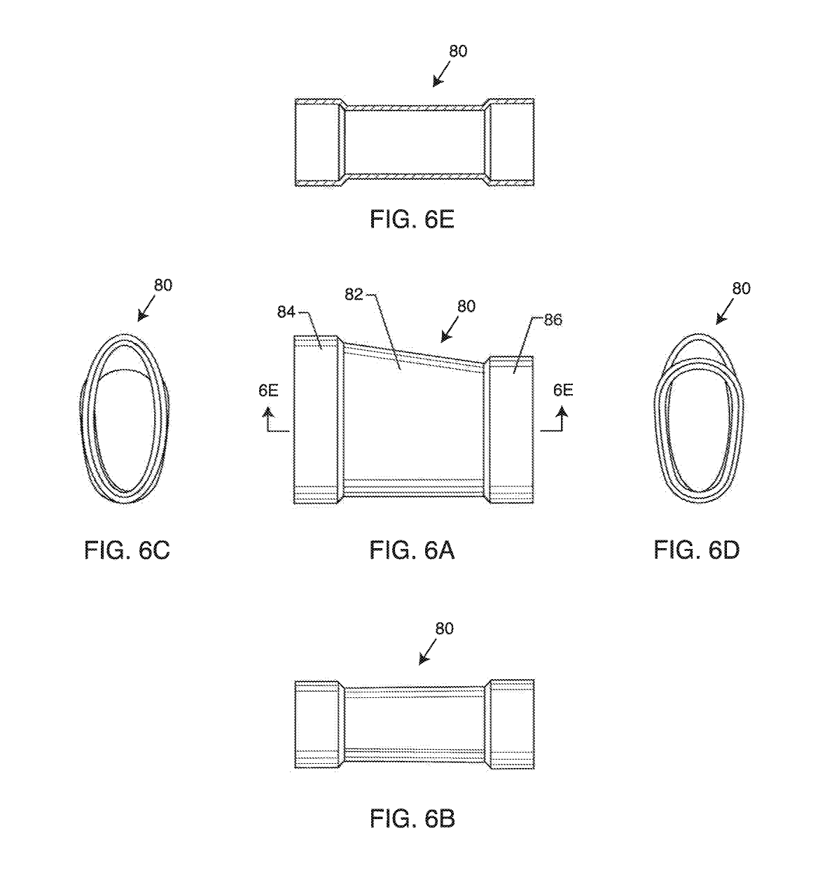

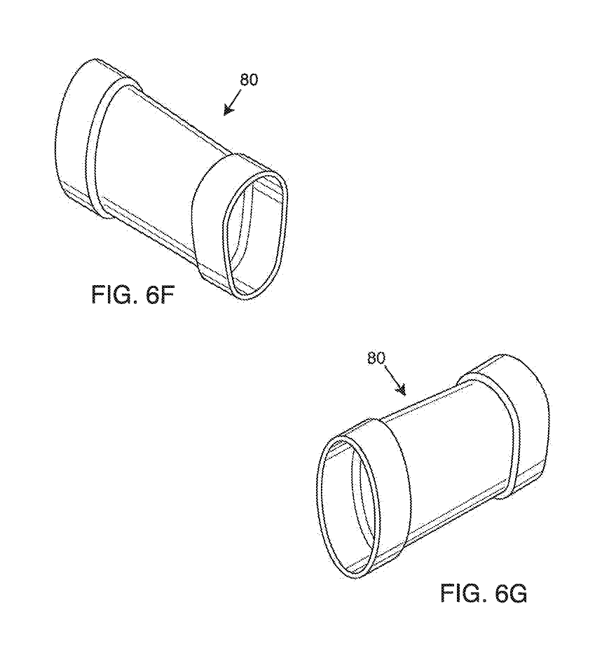

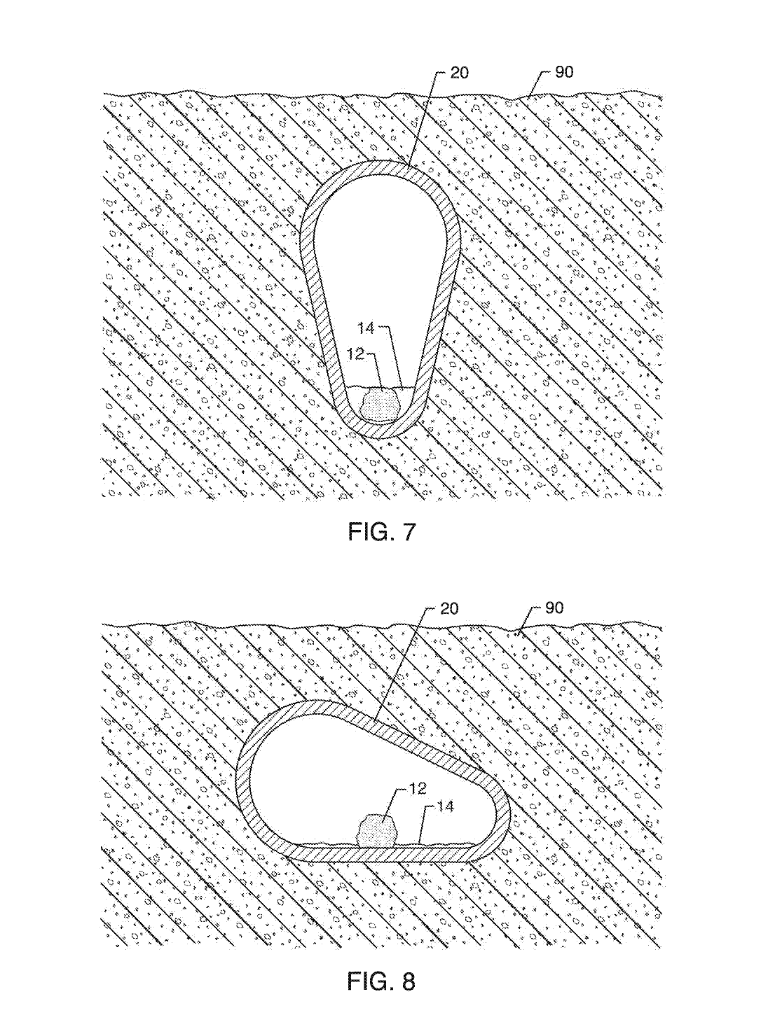

FIGS. 6A-I are yet another exemplary embodiment of a drain pipe fitting 80. The drain pipe fitting 80 has a pipe fitting body 82 comprising a first end 84 in fluidic communication with a second end 86. The first end 84 is connectable to an oval/elliptical shaped pipe. The second end 86 is connectable to a drain pipe similar to that of drain pipe 20 of FIG. 2. As can be seen by one skilled in the art, a plurality of different fittings are possible between various non-circular sectional shapes.

FIG. 7 is a sectional view of an exemplary drain pipe 20 now buried in the ground 90. FIG. 8 is similar to FIG. 7 now with the drain pipe 20 incorrectly oriented. In FIG. 8, the depth of the liquid waste 14 is not enough to properly move the solid waste 12. Therefore, proper orientation of the drain pipe 20 is critical. Alternatively, the exemplary drain pipe 20 would also be incorrectly installed upside-down (not shown) if the larger was radius was located at the bottom. The only proper orientation of the drain pipe 20 is shown in FIG. 7.

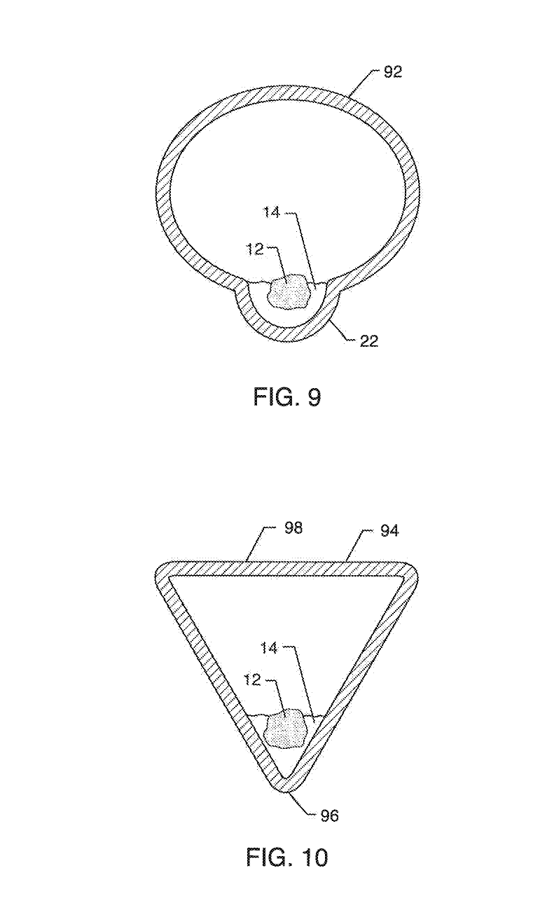

FIG. 9 is a sectional view of another exemplary drain pipe 92 embodying the present invention. The low flow enhancement channel 22 helps move the solid waste 12 along by again creating a greater depth of liquid waste 14.

FIG. 10 is a sectional view of yet another exemplary drain pipe 94 embodying the present invention. The drain pipe 94 is triangular. The bottom 96 of the pipe is also an angle of the triangle. The top 98 of the triangle is a side of the drain pipe that is substantially horizontal.

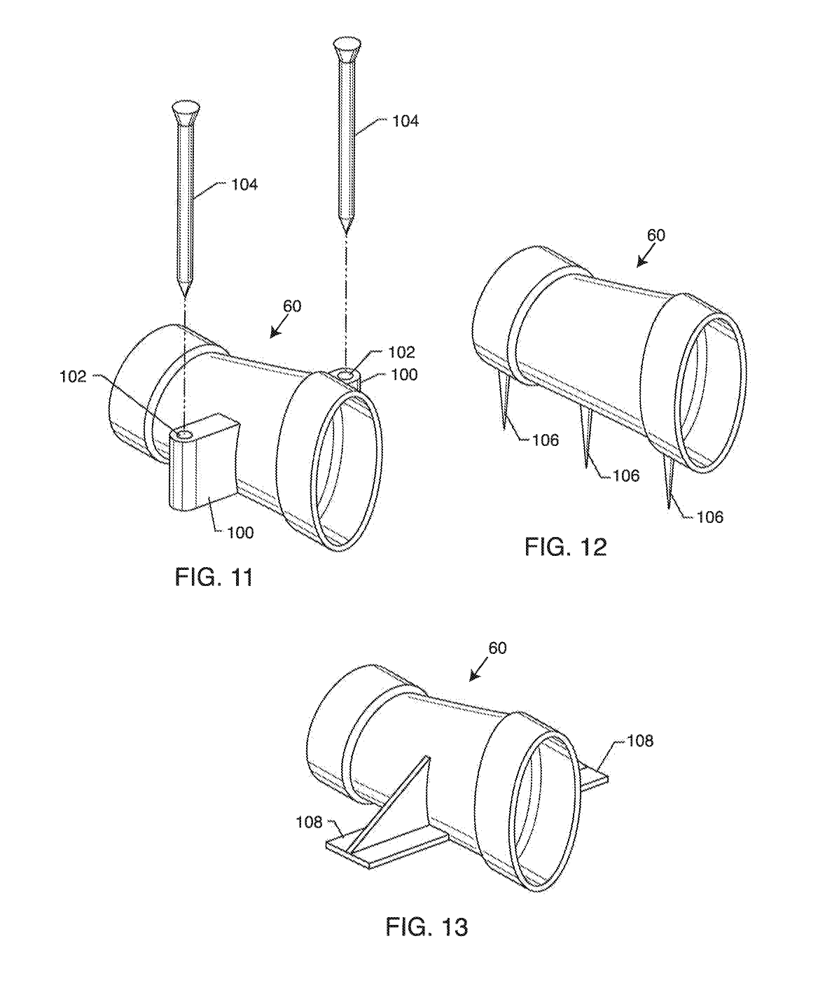

FIG. 11 is a perspective view of an exemplary drain pipe fitting similar to FIGS. 4 now with an outside orientation feature 100. The outside orientation feature 100 is formed as part of the fitting 60. The outside orientation feature 100 helps to properly orient the pipe fitting 60 when installed in the ground or in a building or residence. The outside orientation feature 100 can include a fastener aperture 102. A fastener 104 can then be placed through the fastener aperture 102 to secure the drain pipe fitting 60 in proper orientation. The fastener 104 can be a nail, screw or another other fastener that secures it in the correct orientation. This fitting 60 could also be installed to an overhead support member in a similar fashion where the fasteners 104 are installed from the bottom of the fastener aperture 102 and extend upward. As can be appreciated by one skilled in the art, a multitude of overhead attachment mechanisms and fitting designs are possible.

FIG. 12 is a perspective view of an exemplary drain pipe fitting with an outside orientation feature 100 that is a spike 106 or a plurality of spikes 106.

FIG. 13 is a perspective view of an exemplary drain pipe fitting with an outside orientation feature 100 that is a stand 108. The stand 108 allows easy placement of the fitting along a flat surface to provide proper orientation.

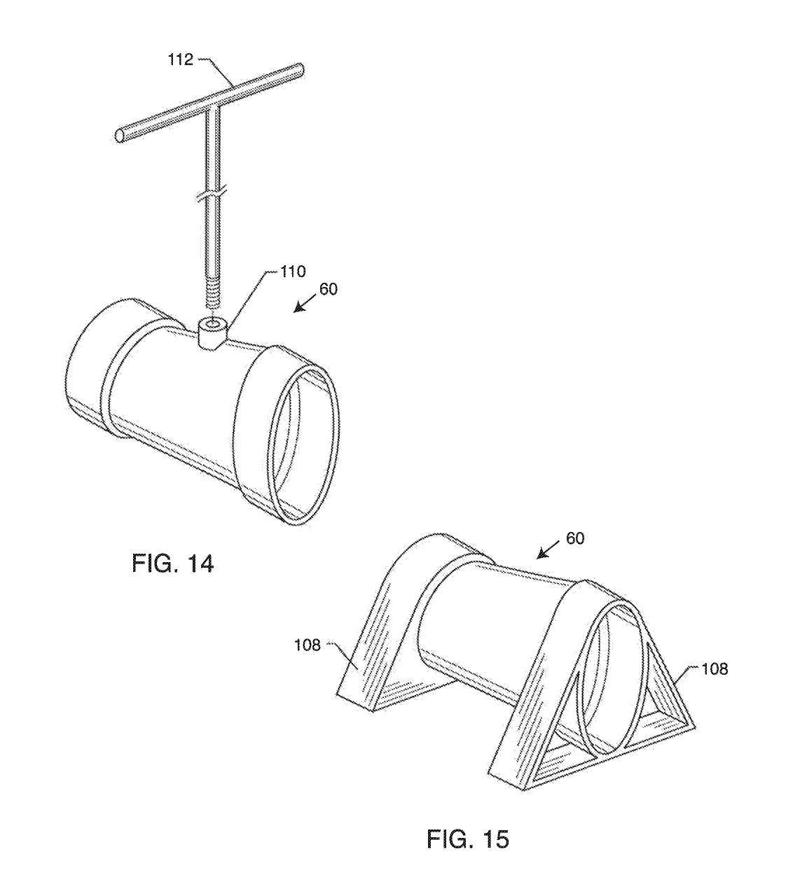

FIG. 14 is a perspective view of an exemplary drain pipe fitting with an auxiliary tool receiver 110 and auxiliary tool 112. In this embodiment, the pipe fitting 60 is intended to be buried in the ground similar to FIG. 7. The auxiliary tool 112 can be screwed into the body of the pipe fitting through the receiver 110. After the pipe fitting 60 is installed in the ground, the tool 112 can be rotated, unscrewed and removed. In an alternative embodiment not shown the tool 112 could be configured to be formed as a single part of the fitting 60 and then later broken away through an area of intended localized failure, such a narrow neck that breaks when twisted.

FIG. 15 is a perspective view of an exemplary drain pipe fitting with an outside orientation feature 100 that is another stand 108.

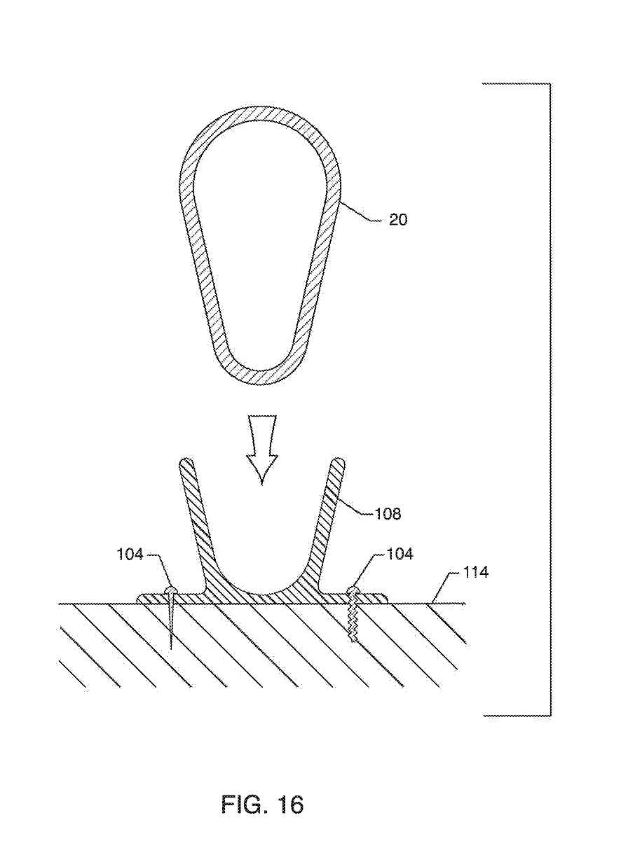

FIG. 16 is a side view of an exemplary drain pipe 20 and stand 108. In this embodiment, the stand 108 is a separate piece from the pipe fitting or pipe 20. The stand 108 can also be fastened to the floor 114 or bonded in place to ensure proper orientation of the pipe 20. It will be appreciated by those skilled in the art that the stand 20 can be used with just the pipe 20 or with a variety of the fittings shown and described herein, such as the fitting of FIG. 5. When the stand 20 is used with the pipe 20, the pipe 20 must be supported every so many feet according to the plumbing code. The distance between such supports depends upon the type of material, wall thickness and the temperature of the drain contents.

The stand 108 can also be configured to attach to a side wall or attach overhead. For example, the drain pipe 20 can be suspended from framing members (not shown) located above the drain pipe 20. A variety of stand 108 configurations can be devised by those skilled in the art that keep the drain pipe 20 in the proper orientation whether it is suspended, attached to a wall or attached to the floor.

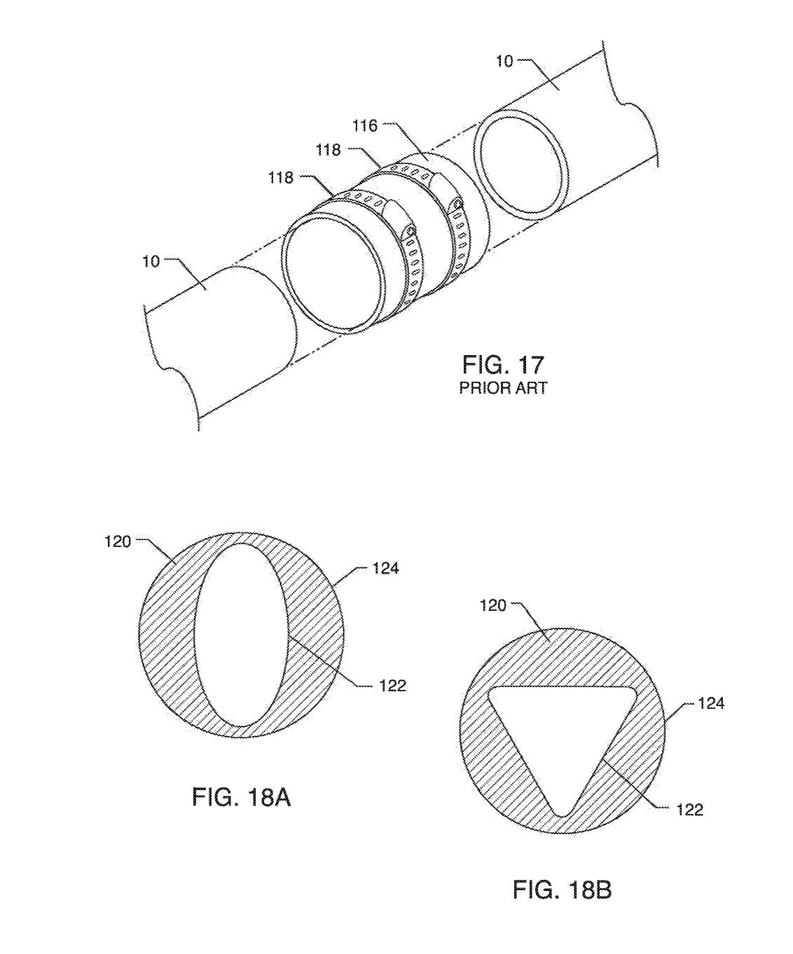

FIG. 17 is a perspective view of a prior art hubless pipe coupler 116. The prior art hubless coupler 116 joins two circular pipes 10 by clamps 118. The pipe 10 is inserted into the coupler 116. The coupler 116 is made from a resiliently flexible and compressible material such a rubber or rubber like foam. The clamp 118 is tightened and exerts a pressure around the pipes thereby sealing them.

FIG. 18A is a side view of an exemplary hubless pipe fitting 120 embodying the present invention and the prior art hubless coupler of FIG. 17. The pipe fitting 120 is similar to the prior art hubless coupler 116, yet has an inside surface 122 that is non-circular and an outside surface 124 that is circular. In this way, a clamp 118 can be still be used that creates a uniform and equal pressure along the entire inside surface 122 such that a seal is formed and maintained. FIG. 18A has an oval inside surface 122 whereas FIG. 18B shows a triangular inside surface 122.

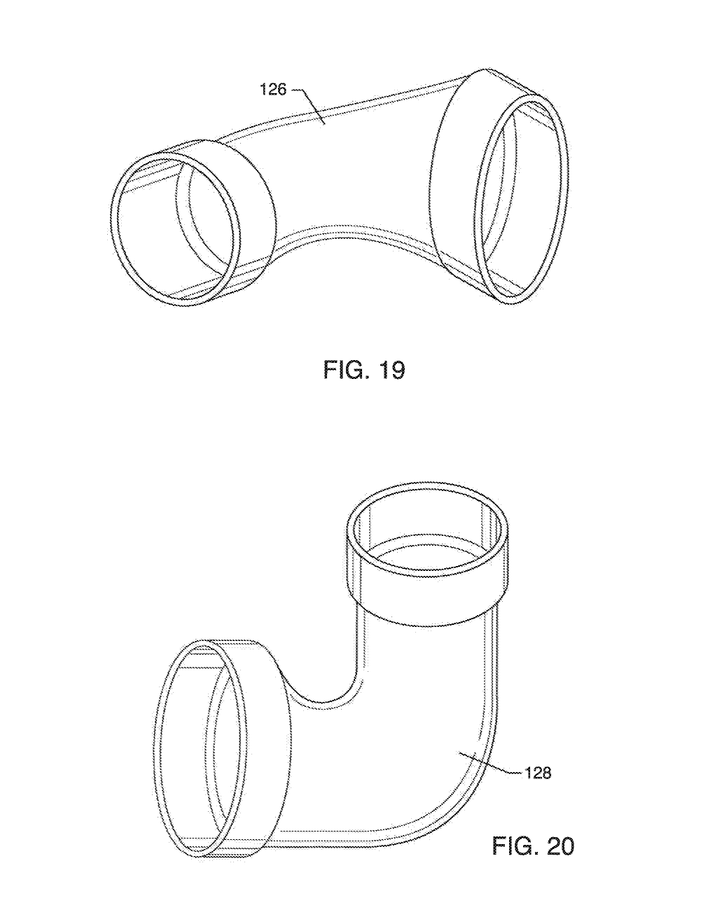

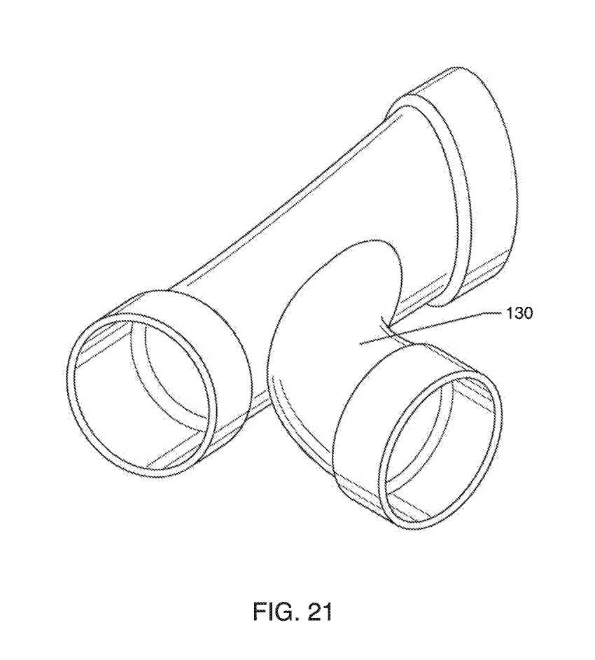

FIGS. 19-21 are perspective views of exemplary drain pipes embodying the present invention. FIG. 19 has a horizontal bend 126. FIG. 20 has a vertical bend. FIG. 21 is a t-style fitting where a third pipe 130 can be spliced into any of the fittings disclosed herein. It is understood by those skilled in the art that a multitude of different fittings are possible mixing and matching the various embodiments shown and described herein and other variations not shown or described but which are in the spirit of this disclosure. This disclosure is not just limited to the precise forms shown herein.

Although several embodiments have been described in detail for purposes of illustration, various modifications may be made to each without departing from the scope and spirit of the invention. Accordingly, the invention is not to be limited, except as by the appended claims.

What is claimed is:

1. A pipe fitting, comprising:
a pipe fitting body comprising a first end in fluidic communication with a second end, where the first and second ends are each configured to receive a pipe;
wherein at least one of the first or second ends comprise a non-circular sectional shape; and
wherein the non-circular sectional shape comprises a low flow enhancement channel disposed at a bottom of the non-circular sectional shape.

2. The fitting of claim 1, wherein the low flow enhancement channel comprises a first radius smaller than an upper or a middle radius of the non-circular sectional shape.

3. The fitting of claim 1, wherein a first area defined as comprising a lower half of the non-circular sectional shape is less than a second area defined as comprising an upper half of the non-circular sectional shape.

4. The fitting of claim 1, wherein a first area defined as comprising a lower third of the non-circular sectional shape is less than a second area defined as comprising a middle third of the non-circular sectional shape.

5. The fitting of claim 1, wherein a first area defined as comprising a lower third of the non-circular sectional shape is less than a third area defined as comprising an upper third of the non-circular sectional shape.

6. The fitting of claim 1, wherein the low flow enhancement channel is configured to comprise a first depth of a fluid that is greater than a second depth of the same fluid in a substantially circular section pipe where the non-circular sectional shape and the circular section pipe comprise substantially the same overall cross sectional area.

7. The fitting of claim 1, wherein the non-circular sectional shape comprises an oval or an ellipse.

8. The fitting of claim 7, wherein a major axis of the oval or ellipse is oriented vertically.

9. The fitting of claim 1, wherein the non-circular sectional shape comprises a triangle.

10. The fitting of claim 9, wherein an angle of the triangle is oriented at the bottom and a side of the triangle is oriented at a top such that the side is oriented substantially horizontal.

11. The fitting of claim 1, wherein both the first and second ends comprise the non-circular sectional shape.

12. The fitting of claim 1, including an outside orientation feature attached to the pipe fitting body.

13. The fitting of claim 12, wherein the outside orientation feature comprises a fastener aperture vertically disposed in relation to the non-circular sectional shape.

14. The fitting of claim 12, wherein the outside orientation feature comprises a spike vertically disposed in relation to the non-circular sectional shape.

15. The fitting of claim 12, wherein the outside orientation feature comprises a stand horizontally disposed in relation to the non-circular sectional shape.

16. The fitting of claim 12, wherein the outside orientation feature comprises an auxiliary tool receiver, such that an auxiliary tool may be removable attached to the auxiliary tool receiver.

17. The fitting of claim 1, including a stand associated with the pipe fitting, the stand configured to accept the pipe fitting body in an orientation where the low flow enhancement channel is disposed at the bottom of the non-circular sectional shape.

18. The fitting of claim 1, wherein the non-circular sectional shape comprises an inside of the pipe fitting body and an outside of the pipe fitting body comprises a circular sectional shape.

19. The fitting of claim 18, wherein the pipe fitting body comprises a resiliently flexible and compressible material.

20. The fitting of claim 1, wherein the pipe fitting body comprises a bend.

21. The fitting of claim 20, wherein the bend is substantially horizontal or vertical.

22. The fitting of claim 1, including a third end in fluidic communication with the first and second ends, the third end also configured to receive the pipe.

23. 1 A pipe fitting, comprising:
a pipe fitting body comprising a first end in fluidic communication with a second end, where the first and second ends are configured to receive a pipe;
wherein at least one of the first or second ends comprise a non-circular sectional shape; and
wherein the non-circular sectional shape comprises a low flow enhancement channel disposed at a bottom of the non-circular sectional shape, wherein the low flow enhancement channel is configured to comprise a first depth of a fluid that is greater than a second depth of the same fluid in a substantially circular section pipe where the non-circular sectional shape and the circular section pipe comprise substantially the same overall cross sectional area.

24. A pipe fitting, comprising:
a pipe fitting body comprising a first end in fluidic communication with a second end, where the first and second ends are configured to receive a pipe;
wherein at least one of the first or second ends comprise a non-circular sectional shape;
wherein the non-circular sectional shape comprises a low flow enhancement channel disposed at a bottom of the non-circular sectional shape, wherein the low flow enhancement channel is configured to comprise a first depth of a fluid that is greater than a second depth of the same fluid in a substantially circular section pipe where the non-circular sectional shape and the circular section pipe comprise substantially the same overall cross sectional area; and
a stand associated with the pipe fitting, the stand configured to accept the pipe fitting body in an orientation where the low flow enhancement channel is disposed at the bottom of the non-circular shape.

25. A non-circular pipe, comprising:
a pipe body comprising a first end in fluidic communication with a second end;
the pipe body comprising a singular cross sectional shape between the first end and second end;
wherein the singular cross sectional shape comprises a non-circular sectional shape;
wherein the non-circular sectional shape comprises a low flow enhancement channel disposed at a bottom of the non-circular sectional shape, wherein the low flow enhancement channel is configured to comprise a first depth of a fluid that is greater than a second depth of the same fluid in a substantially circular section pipe where the non-circular sectional shape and the circular section pipe comprise substantially the same overall cross sectional area, such that a waste blockage is prevented or reduced from accumulating along the bottom of the non-circular sectional shape as compared to the circular section pipe.

26. The pipe of claim 25, including a stand associated with the pipe, the stand configured to accept the pipe body in an orientation where the low flow enhancement channel is disposed at the bottom of the non-circular sectional shape.
